(19) United States
(12) Patent Application Publication
(10) Pub. No.: US 2025/0314628 A1
(43) Pub. Date: Oct. 9, 2025

(54) INTEGRATED PLATFORM FOR MASS SPECTROMETRY

(71) Applicant: LiVeritas Biosciences, Inc., South San Francisco, CA (US)

(72) Inventors: Lieza Marie Danan, Pacifica, CA (US); Jerome Nieva Asuncion, Las Pinas City (PH); Niña Socorro Cortina, Frankfurt am Main (DE)

(21) Appl. No.: 18/628,626

(22) Filed: Apr. 5, 2024

Related U.S. Application Data
(60) Provisional application No. 63/458,048, filed on Apr. 7, 2023.

(51) Int. Cl. G01N 30/86; G01N 30/72; G01N 30/88

(52) U.S. Cl. CPC G01N 30/8651; G01N 30/72; G01N 2030/8831

(57) ABSTRACT

Apparatuses and methods relating generally to mass spectrometry are disclosed. In a method, information regarding a sample is obtained. Theoretical masses of constituent elements of the sample are determined. Experimental data for the sample using mass spectrometry is obtained. Peak areas for the experimental data are determined. The peak areas and the theoretical masses are compared to determine percentages of peak areas. In an apparatus hereof, a storage device storing instructions that when executed by a processor cause the processor to provide for display of an interactive graphical user interface (“iGUI”). The iGUI includes: a laboratory inventory management system module configured for managing projects, samples and inventories; an electronic lab notebook module in communication laboratory inventory management system module; a platform module in communication with the electronic lab notebook module; and the platform module provides access to a set of analytical workflows and a set of intelligent tools.

### CROSS-REFERENCE TO RELATED APPLICATION(S)

This application hereby claims priority to U.S. provisional patent application Ser. No. U.S. 63/458,048, filed on Apr. 7, 2023, the entirety of which is hereby incorporated by reference herein for all purposes.

### FIELD

The following description relates to information processing. More particularly, the following description relates to information processing for mass spectrometry.

### BACKGROUND

Mass spectrometry is used to identify and measure a chemical composition of a sample. Generally, a sample is ionized, which means electrons are added or removed to create ions, and mass-to-charge ratio of resulting ions is measured.

A sample may be introduced into a mass spectrometer and vaporized into a gas. Such gas may be ionized using either an electron beam or a laser, which creates ions with a positive or negative charge. These ions may be separated by their mass-to-charge ratio using a magnetic field or an electric field. Separating ions based on their weight and charge creates a spectrum of ions that can be detected and analyzed. A resulting spectrum can be used to identify a chemical composition of a sample, including presence and abundance of different elements and molecules. This information can be used to determine molecular components of a molecule or molecular structure of such sample and to identify potential contaminants or impurities.

However, there are many issues with using mass spectrometry, including an excessive amount of education, work experience and scientific creativity for obtaining quality results from mass spectrometry. The following disclosure addresses one or more of the above-mentioned limitations.

### SUMMARY

In accordance with one or more below described examples, a method relating generally to mass spectrometry is disclosed. In such a method, information regarding a sample is obtained. Theoretical masses of constituent elements of the sample are determined. Experimental data for the sample using mass spectrometry is obtained. Peak areas for the experimental data are determined. The peak areas and the theoretical masses are compared to determine percentages of peak areas in comparison to the theoretical masses associated therewith.

In accordance with one or more below described examples, an apparatus relating generally to mass spectrometry is disclosed. In such an apparatus, a storage device storing instructions that when executed by a processor cause the processor to provide for display of an interactive graphical user interface. The interactive graphical user interface includes: a laboratory inventory management system module configured for managing projects, samples and inventories; an electronic lab notebook module in communication laboratory inventory management system module; a platform module in communication with the electronic lab notebook module; and the platform module providing access to a set of analytical workflows and a set of intelligent tools.

### BRIEF DESCRIPTION OF THE DRAWING(S)

Accompanying drawing(s) show exemplary embodiment(s) in accordance with one or more aspects of exemplary apparatus(es) or method(s). However, the accompanying drawings should not be taken to limit the scope of the claims, but are for explanation and understanding only.

FIG. 1-1 is a block diagram depicting an example of a conventional mass spectrometry system or mass spectrometer (“MS system” or “MS”).

FIG. 1-2 is a block diagram depicting an example of a data analyzer system.

FIG. 2-1 is a pictorial/block diagram depicting an example of a system architecture.

FIG. 2-2 is a pictorial block diagram of a project interactive graphical user interface or iGUI (“Project iGUI”).

FIG. 2-3 is a pictorial/block diagram of a system overview iGUI (“System iGUI”).

FIG. 3-1 is a flow diagram depicting an example of a peak flow.

FIG. 3-2 is a flow diagram depicting another example of a peak flow.

FIG. 4 is a pictorial diagram depicting an example of a network.

FIG. 5 is a block diagram depicting an example of a portable communication device (“mobile device”).

FIG. 6 is a block diagram depicting an example of a computer system.

### DETAILED DESCRIPTION

In the following description, numerous specific details are set forth to provide a more thorough description of the specific examples described herein. It should be apparent, however, to one skilled in the art, that one or more other examples and/or variations of these examples may be practiced without all the specific details given below. In other instances, well-known features have not been described in detail so as not to obscure the description of the examples herein. For ease of illustration, the same number labels are used in different diagrams to refer to the same items; however, in alternative examples the items may be different.

Exemplary apparatus(es) and/or method(s) are described herein. It should be understood that the word “exemplary” is used herein to mean “serving as an example, instance, or illustration.” Any example or feature described herein as “exemplary” is not necessarily to be construed as preferred or advantageous over other examples or features.

Before describing the examples illustratively depicted in the several figures, a general introduction is provided to further understanding.

Mass spectrometry is used in a wide range of scientific fields, including chemistry, biology, and medicine. It is a powerful form of instrumentation for identifying and analyzing complex mixtures of chemicals and can be used to identify unknown compounds, monitor chemical reactions, and detect trace amounts of chemicals in samples.

As described below in additional detail, workflow selection and results analysis is automated in order to reduce barriers associated with using mass spectrometry and obtaining quality results.

Along those lines, information regarding a sample is obtained. Theoretical masses of constituent elements of the sample are determined. Experimental data for the sample using mass spectrometry is obtained. Peak areas for the experimental data are determined. The peak areas and the theoretical masses are compared to determine percentages of peak areas in comparison to the theoretical masses associated therewith.

In an example, a report is generated including results from the comparing of the peak areas and the theoretical masses.

In an example, the experimental data is of a form of a subject dataset associated with the sample. The subject dataset includes mass spectrometry-based data. The peak areas correspond to concentrations of the constituent elements from the subject dataset.

In an example, the sample is of a drug substance.

In an example, the drug substance is a biologic substance.

In an example, a reference dataset is generated for the subject dataset.

In an example, a subject distribution for the subject dataset is generated. A reference distribution for the reference dataset is generated. The subject distribution is compared with corresponding components in the reference distribution to determine a set of relative values.

In an example, the set of relative values is converted to vectors representing relative abundance or lack thereof of the drug substance in the sample.

In accordance with one or more below described examples, an apparatus relating generally to mass spectrometry is disclosed. In such an apparatus, a storage device storing instructions that when executed by a processor cause the processor to provide for display of an interactive graphical user interface. The interactive graphical user interface includes: a laboratory inventory management system module configured for managing projects, samples and inventories; an electronic lab notebook module in communication laboratory inventory management system module; a platform module in communication with the electronic lab notebook module; and the platform module providing access to a set of analytical workflows and a set of intelligent tools.

With the above general understanding borne in mind, various configurations for systems, and methods therefore, for automating mass spectrometry workflow selection and results analysis are generally described.

Reference will now be made in detail to examples which are illustrated in the accompanying drawings. In the following detailed description, numerous specific details are set forth in order to provide a thorough understanding of the following described implementation examples. It should be apparent, however, to one skilled in the art, that the implementation examples described below may be practiced without all the specific details given below. Moreover, the example implementations are not intended to be exhaustive or to limit scope of this disclosure to the precise forms disclosed, and modifications and variations are possible in light of the following teachings or may be acquired from practicing one or more of the teachings hereof. The implementation examples were chosen and described in order to best explain principles and practical applications of the teachings hereof to enable others skilled in the art to utilize one or more of such teachings in various implementation examples and with various modifications as are suited to the particular use contemplated. In other instances, well-known methods, procedures, components, circuits, and/or networks have not been described in detail so as not to unnecessarily obscure the described implementation examples.

For purposes of explanation, specific nomenclature is set forth to provide a thorough understanding of the various concepts disclosed herein. However, the terminology used herein is for the purpose of describing particular examples only and is not intended to be limiting. As used herein, the singular forms “a”, “an” and “the” are intended to include the plural forms as well, unless the context clearly indicates otherwise. As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. It will also be understood that the term “and/or” as used herein refers to and encompasses any and all possible combinations of one or more of the associated listed items. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof. It will also be understood that, although the terms first, second, etc., may be used herein to describe various elements, these elements should not be limited by these terms, as these terms are only used to distinguish one element from another.

Some portions of the detailed descriptions that follow are presented in terms of algorithms and symbolic representations of operations on data bits, including within a register or a memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those involving physical manipulations of physical quantities. Usually, though not necessarily, these quantities take the form of optical, electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

Concepts described herein may be embodied as apparatus, method, system, or computer program product. Accordingly, one or more of such implementation examples may take the form of an entirely hardware implementation example, an entirely software implementation example (including firmware, resident software, and micro-code, among others) or an implementation example combining software and hardware, and for clarity any and all of these implementation examples may generally be referred to herein as a “circuit,” “module,” “system,” or other suitable terms. Furthermore, such implementation examples may be of the form of a computer program product on a computer-usable storage medium having computer-usable program code in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (“RAM”), a read-only memory (“ROM”), an erasable programmable read-only memory (“EPROM” or Flash memory), an optical fiber, a portable compact disc read-only memory (“CD-ROM”), an optical storage device, a transmission media such as those supporting the Internet or an intranet, or a magnetic storage device. The computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (“RF”) or other means. For purposes of clarity by way of example and not limitation, the latter types of media are generally referred to as transitory signal bearing media, and the former types of media are generally referred to as non-transitory signal bearing media.

Computer program code for carrying out operations in accordance with concepts described herein may be written in an object-oriented programming language such as Java, Smalltalk, C++ or the like. However, the computer program code for carrying out such operations may be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (“LAN”) or a wide area network (“WAN”), or the connection may be made to an external computer (for example, through the Internet using an Internet Service Provider).

Systems and methods described herein may relate to an apparatus for performing the operations associated therewith. This apparatus may be specially constructed for the purposes identified, or it may include a general-purpose computer selectively activated or reconfigured by a computer program stored in the computer.

Notwithstanding, the algorithms and displays presented herein are not inherently related to any particular computer or other apparatus. Various general-purpose systems may be used with programs in accordance with the teachings herein, or it may prove convenient to construct a more specialized apparatus to perform the operations. In addition, even if the following description is with reference to a programming language, it should be appreciated that any of a variety of programming languages may be used to implement the teachings as described herein.

One or more examples are described below with reference to flowchart illustrations and/or block diagrams of methods, apparatus (including systems) and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the Figures illustrate the architecture, functionality, and operation of possible implementations of apparatuses (including systems), methods and computer program products according to various implementation examples. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

It should be understood that although the flow charts provided herein show a specific order of operations, it is understood that the order of these operations may differ from what is depicted. Also, two or more operations may be performed concurrently or with partial concurrence. Such variation will depend on the software and hardware systems chosen and on designer choice. It is understood that all such variations are within the scope of the disclosure. Likewise, software and web implementations may be accomplished with standard programming techniques with rule-based logic and other logic to accomplish the various database searching operations, correlation operations, comparison operations and decision operations. It should also be understood that the word “component” as used herein is intended to encompass implementations using one or more lines of software code, and/or hardware implementations, and/or equipment for receiving manual inputs.

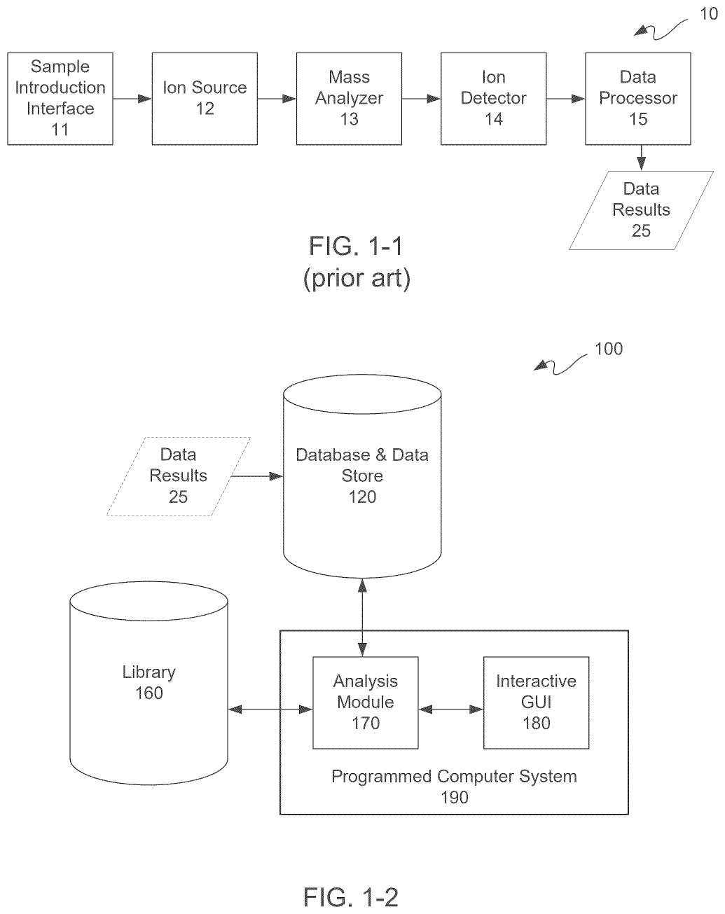

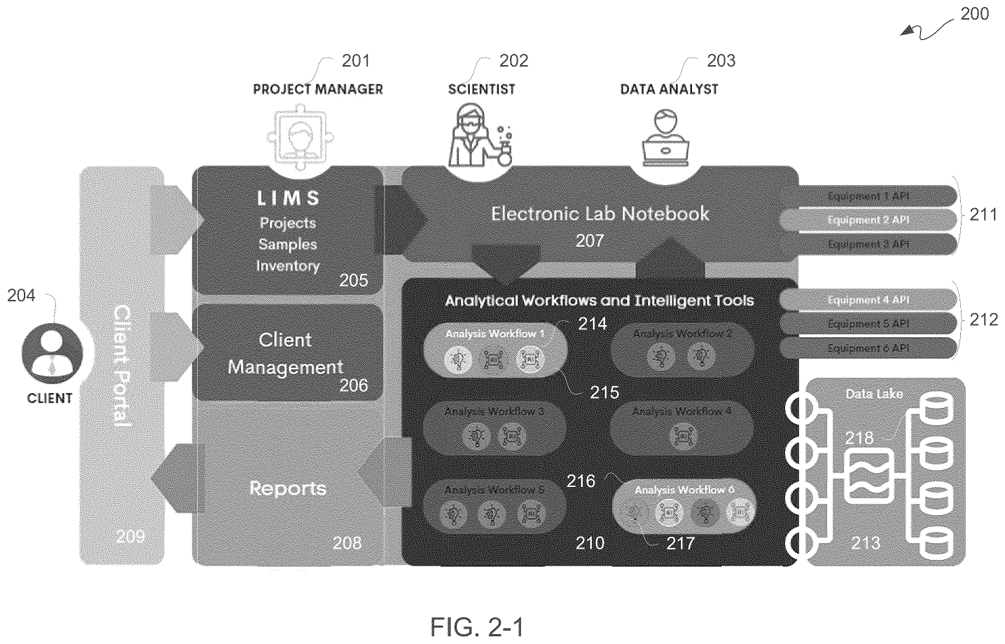

FIG. 1-1 is a block diagram depicting an example of a conventional mass spectrometry system or mass spectrometer (“MS system” or “MS”) 10. Because one or more examples described below may involve use of an MS system 10, examples of an MS system 10 are described.

MS system 10 may include a sample introduction interface 11. Sample introduction interface 11 may include an inlet to an ion source (“ionizer”) 12. Sample introduction interface 11 may be a liquid chromatography system (“LC” system or “LC”), which may for example include an autosampler with liquid chromatography pumps, such as for example a high-performance LC or HPLC system in an LC-MS version of MS system 10. However, in another example of MS system 10, a liquid chromatography frontend for sampling may be absent. Generally, for an LC-MS system, a frontend includes a solvents mobile phase followed by a samples multiple component mixtures phase. Optionally, an LC may include a UV, a flow splitter, one or more columns, a fraction collector, or other modules.

For example, a sample may be a composition of chemical constituents in a complex mixture. An LC of MS system 10 may be a component for performing a separation technique for separating a sample to be analyzed into chemical constituents. An MS system 10 may be used for performing mass spectrometry on an effluent of such an LC, namely chemical constituents that elute from chromatography. An LC may be an ultra-high pressure liquid chromatograph (“UHPLC”). In other examples, other chemical separation instrumentation may be used. Other chemical separation instruments may be configured for ion-mobility spectrometry (“IMS”), capillary zone electrophoresis (“CZE” or “CE”), high-performance liquid chromatography (“HPLC”), or monolithic liquid chromatography.

A factor in determining system configuration may be sample size, or more particularly molecular size of molecules forming a sample of a chemical compound. Generally, “small molecules” have a molecular mass of less than 2,000 Daltons, that result in a parameter that is characteristic of a given chemical species, and are compatible with any “soft ionization technique,” such as for example APCI (Atmospheric Pressure Chemical Ionization), ESI (Electrospray Ionization), or MALDI (Matrix Assisted Laser Desorption/Ionization). Generally, ‘large molecules” have a molecular mass substantially greater than 2,000 Daltons.

For example, protein size may be measured in daltons or Daltons as a measure of molecular weight (“Mw” or “MW”). One Dalton is defined as 1/12 of the mass of an unbound neutral carbon-12 atom in its nuclear and electronic ground state and at rest, which is 1.660539×10⁻²⁷ grams. For example, most proteins have masses on the order of thousands of Daltons, so a term kilodalton (“kD” or “kDa”) is often used to describe protein molecular weight. Aspirin, which has about 21 atoms, has MW 180, namely 180 Daltons; hGH, which has about 3,000 atoms, has MW 22 kDa; IgG antibody, which has about 25,000 atoms, has MW 150 kDa; pegylated proteins, which have about 150,000 atoms, have MW 1,200 kDa or 1.2 megadaltons (“MDa”); generally AAV having 3 proteins and a transgene, which may be thought of as having about 600,000 atoms in total, has a combined MW of about 5,200 kDa or 5.2 MDa; and generally cell therapies, which may be thought of as having about 100 trillion atoms in total, have a combined MW of about 1 quadrillion Daltons or 1 petadalton. From this sampling, it should be appreciated that as molecular size increases, molecular complexity likewise increases, and such complexity may result in big data datasets. As described below in additional detail, big data analytics may be used on such big data datasets.

An LC may use high pressure to force a mobile phase (liquid) and a sample, injected into such mobile phase, through a column. A column, which may be changed out of an LC or removed entirely, may be sized according to an intended purpose. Along those lines, a column may include what may be generally thought of as a “filter” with a pore size, and such pore size in some workflows may be used for limiting size of a molecule or chemical constituents thereof into an MS.

Various chemical constituents of a sample elute through a column at different speeds and thus exit such a column at different times. The time that a chemical constituent of a sample takes to travel through and exit a column is generally referred to as the retention time of a corresponding chemical constituent.

The output of a column may be fed into an ionizer 12. For systems using liquid chromatographs, an ionizer 12 may further convert an effluent exiting from a column into an ionized gas. For example, ionizer 12 may be an electrospray ionization device, an atmospheric pressure chemical ionizer (“APCI”), or other atmospheric pressure or “soft” desorption ionization device.

In an electrospray ionization (“ESI”) MS system version of MS system 10, a capillary or microfluidic device of a frontend to an MS instrument of an MS system 10 may be used to introduce droplets of a sample in solution for ionization by ionizer 12, and may be part of such ionizer 12. Other types of MS systems may be used, such as for example gas chromatography (“GC”) MS. Furthermore, other configurations include but are not limited to LC-MS/MS.

In an ESI-MS system, ionizer 12 may induce an electric field to shape a droplet into a cone or cone-like shape, sometimes referred to as a Taylor cone. For an ESI-MS system among other versions of MS system 10, ionizer 12 ionizes such droplets, such as for output at an egress end of a capillary or other microfluidic device, generally for attraction to a charge plate of an ion detector. Furthermore, other types of ion sources may be used, such as matrix-assisted laser desorption/ionization (“MALDI”), among others.

Ionizer 12 may feed ionized samples to a mass analyzer 13. An ionized gas or liquid may pass through focusing rings or a high-voltage capillary of an MS to a mass analyzer 13, namely a mass analysis section of an MS. A mass analysis section may be of a quadrupole ion trap mass spectrometer, a time-of-flight (“TOF”) mass spectrometer, a quadrupole mass spectrometer without an ion trap, Fourier transform ion cyclotron resonance (“FT-ICR”), orbitrap MS, or another type of mass analysis section with another type of ion trap.

Mass analyzer 13 may be referred to as an MS instrument. Generally, mass analyzer 13 sorts ions for ion detector 14. A mass analyzer 13 is generally coupled to provide an output to an ion detector 14 of an MS 10. Mass analyzer 13 and ion detector 14 may be subject to vacuum conditions provided by vacuum pumps. Furthermore, ion source 12 may be subject to such vacuum conditions. Data output from ion detector 14 may be provided to an information handling, storing, processing and displaying system, namely data processor 15.

For example, output of ion detector 14 may be provided to a programmed computer configured with a digitizer card (“data processor”) 15. Data processor 15 may be configured to convert raw data into a spectrum, including use of a deconvolution. This converted data may be output as data results 25 for subsequent processing. Data results 25 output, which may be sent to a digitizer board in a computer, may include separation and mass spectrometry data in a three-dimensional configuration. Optionally, separation and mass spectrometry data may be stored in tables or other data structures in local memory or on local storage devices, or via other types of data storage, of data processor 15.

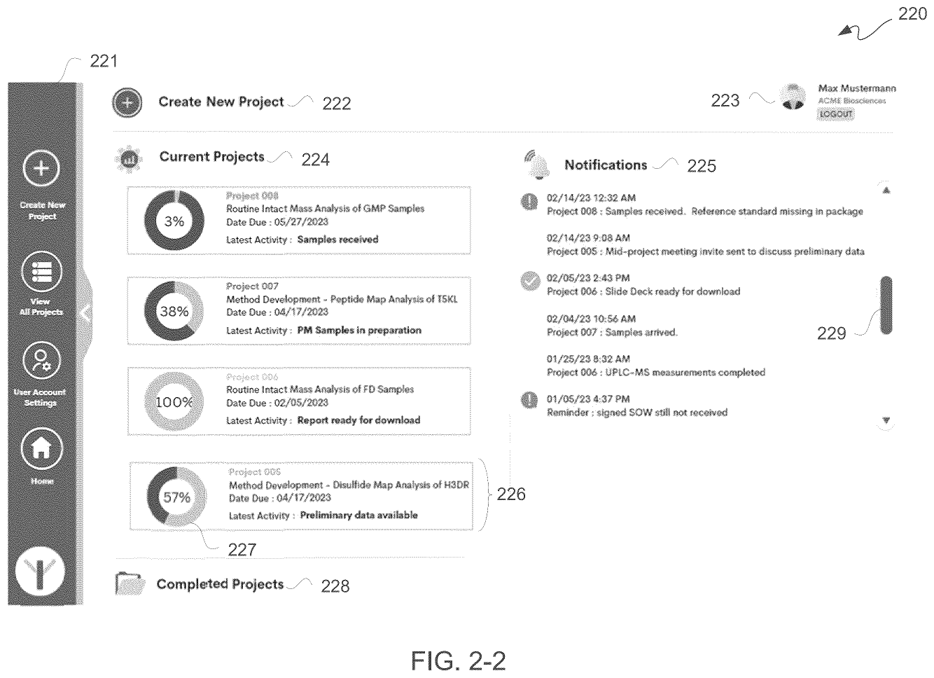

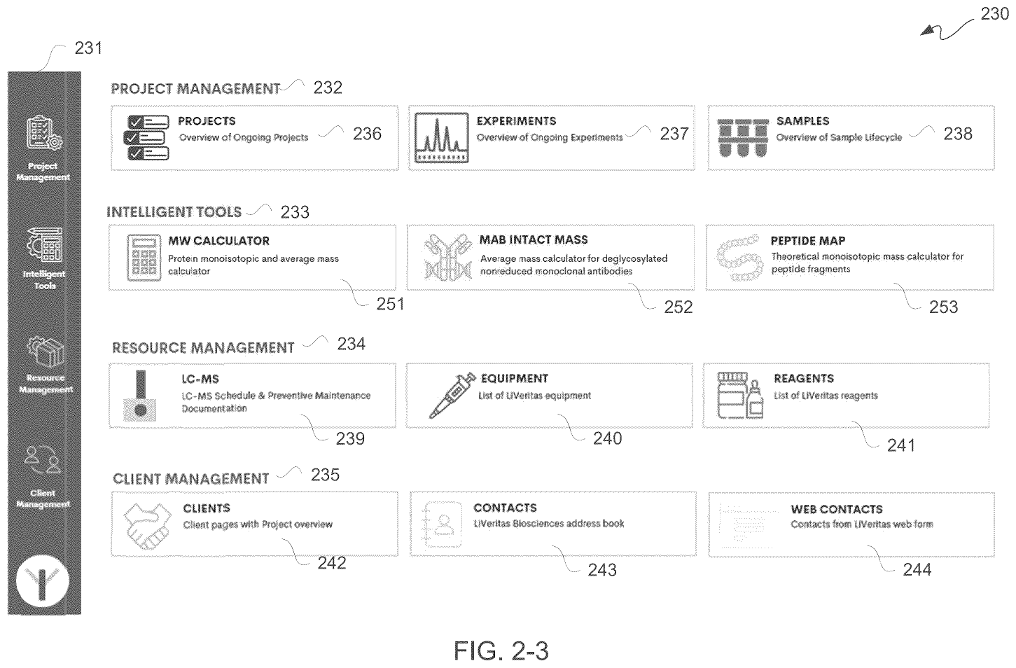

FIG. 1-2 is a block diagram depicting an example of a data analyzer system 100. Data results 25, which may be encrypted, output from data processor 15 may be collected and stored in a database and data store (“storage”) 120. Such data results 25 may be stored in storage 120 in encrypted form, and storage 120 may be cloud-based storage. Data analyzer system 100 is further described with simultaneous reference to FIGS. 1-1 and 1-2.

For purposes of clarity by way of example and not limitation, an LC-MS system is assumed; however, as indicated above, other types of systems may be used without principally departing from the foregoing description. Digitized data may be used for storing chromatography and mass spectrometry data. For example, LC/MS data may be stored as raw digitized data, as well as stored in a structured form, in storage 120. In other examples, other types of separation data may be used.

Data analyzer system 100 may include a programmed computer system 190. Programmed computer system 190 may be programmed with an analysis module 170 and an interactive graphical user interface (“iGUI”) 180 for communication with one another. Analysis module 170 may be in communication with database/data store 120, as well as a library 160. Analysis module 170 may be configured to determine a composition of a sample having been processed through an LC-MS 10.

Analysis module 170 may use comparison of analysis results to a library of chemical information listing characteristics of various chemical entities to data in storage 120. A user may use iGUI 180 to, for example, direct an LC-MS system to perform one or more separation and mass spectrometry operations, and then view results therefrom. A user may use iGUI 180 to instruct analysis module 170 to perform automated comparison and identification routines to determine a composition of a sample based on best matches with entities in library 160. A user may use iGUI 180 to access chemical library 160 to manually compare library entities with analysis results, or review/confirm conclusions of automated identification routines.

FIG. 2-1 is a pictorial/block diagram depicting an example of a system architecture 200. System architecture 200 may be used in or with a data analyzer system 100. System architecture 200 is a cloud-based architecture, and a client portal may be to a web-enable device with access to the Internet or other widely distributed network with a virtual private network (“VPN”), two-factor authentication, or other security for controlled access to system architecture 200.

System architecture 200 may be accessible by a client 204 or other user through a client portal 209 in an encrypted communication tunnel, such as a VPN or other form of security using a transport layer security (“TLS”) protocol. Generally, user management, such as user roles and permissions, may determine what part of a system a user is authorized to access.

A project manager 201, a scientist 202, or a data analyst may be granted access to a laboratory inventory management system or LIMS 205 or a client management interface 206. LIMS 205 may be used for managing projects, samples or inventory. A reporting interface (“reports”) 208 may be used to obtain or review reports. Client portal 209 may allow clients to upload sample information during submission including relevant files and to download reports (such as in PDF files) created or generated as part of system architecture 200.

A project manager 201 may manage through LIMS 205, client management interface 206, or reporting interface 208. Project manager 201 may be used to control access, among other management functions. LIMS 205 may be used to track projects, samples, or inventory. An electronic lab notebook or ELN 207 may be used by a scientist 202 or a data analyst 203. ELN 207 may be in communication with LIMS 205 or a set of equipment 211. In this example, there are 3 pieces of equipment, namely Equipment 1, 2 and 3, associated with or accessible by ELN 207 through corresponding application programming interfaces or APIs corresponding to such equipment.

ELN 207 may be in communication with a set of analytical workflows and a set of intelligent tools of platform 210. Platform 210 may be accessible by scientists 202 or data analysts 203. In this example, there are 6 analysis workflows 1 through 6; however, in other examples fewer or more than six analysis workflows may be available. For example, a scientist 202 may select one or more analysis workflows to be performed by an LC-MS 10 for a specific selected sample or samples. Results of each such an analysis workflow for each of such samples may be reported via a reporting interface 208 accessible through a client portal 209.

ELN 207 may provide scientists 202 or analysts 203 access to one or more types of laboratory equipment 211 or 212 under coded control through corresponding APIs. Scientists or analysts may use ELN 207 to both select analytical work flows and intelligent tools, as well as to obtain results from same or in combination with selected equipment through corresponding APIs.

In this example, platform 210 provides access to 3 pieces of equipment, namely Equipment 4, 5 and 6, through corresponding APIs. However, in other examples, sets of equipment 211 and 212 each may have fewer or more pieces of equipment. Platform 210 may further provide access to a data lake 213. In this example data lake includes multiple storage containers bussed together 218.

Analytical workflows or intelligent tools may be associated with another set of equipment, and this other set of equipment may be accessible via corresponding APIs. Additionally, analytical workflows or intelligent tools of platform 210 may have access to multiple databases or datastores collectively forming data lake 213.

In this example, two of six analysis workflows 1 through 6 of platform 210 are actively being used together. More particularly, in this example, analysis work flows 215 and 216 may be used together in tandem, simultaneously, lockstep or pipelined with one another, with or without data dependent exchanges. For example, a first workflow may generate a piece of data which is shared with a second workflow and vice versa, and both such first and second workflows may be operated at the same time, such a pipelined for example. In this example, analysis work flow 215 has 3 intelligent tools 214, and analysis work flow 216 has 4 intelligent tools 217, where each set of intelligent tools is represented by a corresponding icon. An ability to operate two analysis workflows simultaneously, and in some instances with one or more interrelationships, to obtain corresponding sets of data may provide insightful correlation data.

Platform 210 may be used for large molecule research, such as for molecular innovation, bioprocess innovation, and transfer to and in clinical research. The FDA or other governmental regulatory body may require certain types of analysis workflows to be performed. Platform 210 may include a set of such required workflows.

For example, antibody quality analytics may include possible modifications and critical quality attributes or CQAs. Along those lines, platform 210 may be used for example for identity, fragmentation, aggregation, glycosylation, disulfide bonds, chain mispairing, N-terminal heterogeneity, C-terminal heterogeneity, or amino acid modifications. Along those lines, MS may be used for high-resolution intact mass, peptide mapping, multiD-HPLC MS, or epitope mapping.

Generally, platform 210 may be used for providing instruction for sample preparation and LC-MS 10 set up (generally “LC-MS parameters”), including capture and conversion of data. Platform 210 from data results 25 may automatically organize and store such data results in association with LC-MS parameters. Through AI/ML tools, which may allow for supervisions, such data results may be searched and analyzed. Furthermore, such processed data may be reported, including with visualization tools

FIG. 2-2 is a pictorial block diagram of a project interactive graphical user interface or iGUI (“Project iGUI”) 220. Project iGUI 220 is further described with simultaneous reference to FIGS. 2-1 and 2-2.

Project iGUI 220 may be accessible via a client portal 209. A client/user icon 223 may be displayed. In this example, some details for user, projects and notifications are presented for purposes of illustration only and not limitation, as these or other examples may be used.

In a user interface column 221, a user/client may create a new project, view all projects, set/change user account setting, or return to a home dashboard screen. In a next column, a list of current projects 224 may be provided along with a button to create a new project 222 to be grouped with such list. Furthermore, a completed projects folder 228 may be provided.

Each project, for example project 226, may display a state of completion icon 227, which may be obtained from a project planner, as well as a project number, method development or routine testing being performed on an identified sample, and a due date. Additionally, a latest activity may be indicated as obtained from a project planner. Furthermore, which method development or which routine testing activity type may be displayed, such as for example routine intact mass analysis, method development for peptide map analysis, or method development for disulfide map analysis.

A rightmost column may display notifications 225 for all projects or filtered down for a selected project. A slider bar 229 may be used to slide up and down both notifications and projects.

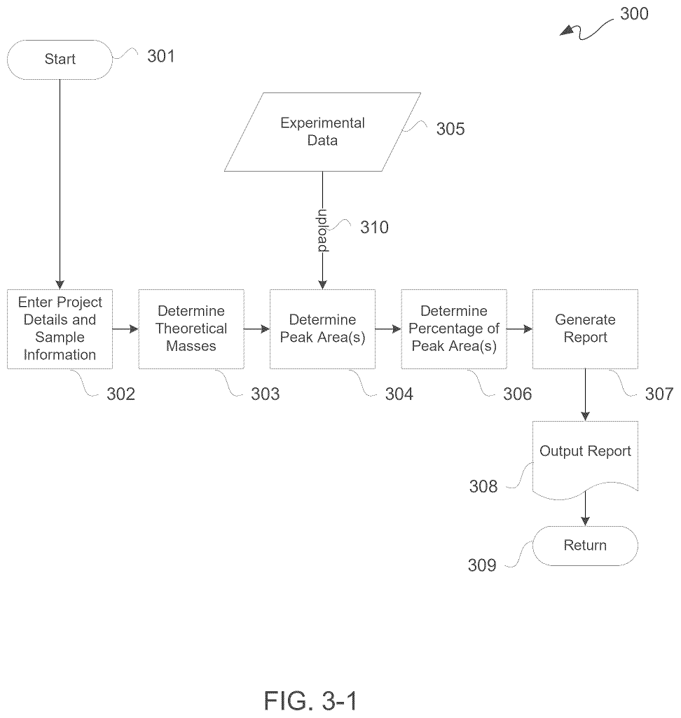

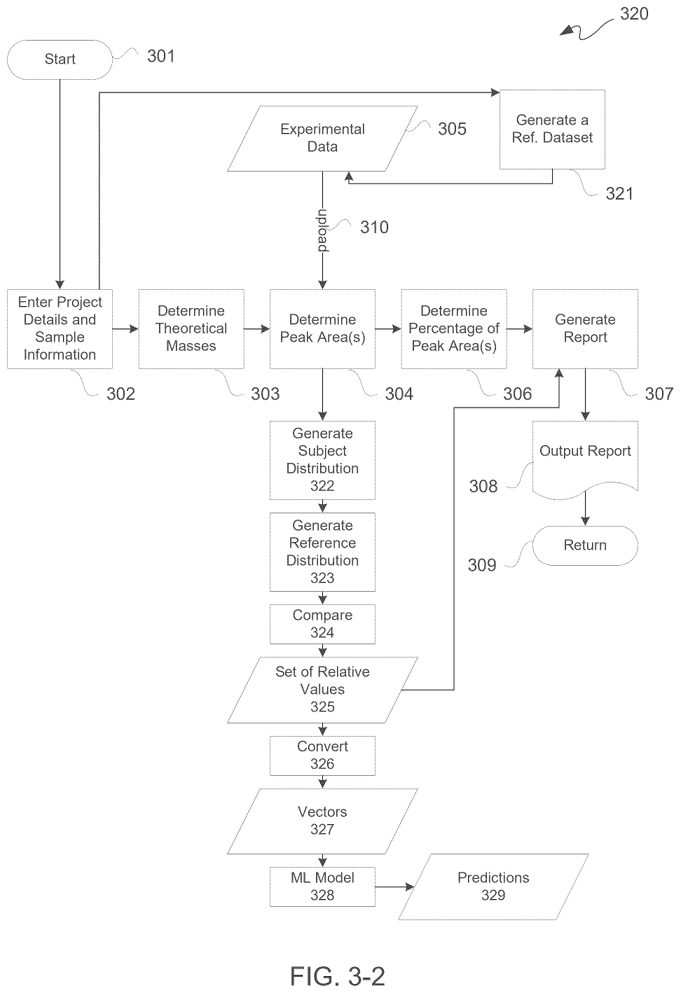

FIG. 2-3 is a pictorial/block diagram of a system overview iGUI (“System iGUI”) 230. System iGUI 230 is further described with simultaneous reference to FIGS. 2-1 through 2-3.

System iGUI 230 may be accessible through a client management interface 206 or through an ELN 207. While a single portal may be created for both client access and internal system user access, such as client portal 209, by roles and permissions, client portal 209 may be a separate portal from one or more internal user portals, such as for any one or more of internal users 201 through 203.

In a user interface column 231, a project management interface 234, an intelligent tools interface 233, a resource management interface 234, or a client management interface 235 may be selected. Examples of each of these four interfaces 232 through 235 are provide as rows to the right of such leftmost column.

In this example of a project management interface 232, projects 236, experiments 237, or samples 238 may be selected to respectively obtain overviews of one or more items in each of these categories.

In this example of an intelligent tools interface 233, there are three types of intelligent tools; however, in another example fewer or more than three types of intelligent tools may be implemented for calculation or determination of one or more masses. Thus, an internal user need not manually calculate such masses.

Molecular weight or MW module 251 is configured to automatically determine protein monoisotopic mass and average mass of a protein-based molecule. Monoclonal antibody (“MAB” or “MAb”) intact mass module 252 is configured to automatically determine average mass for an intact mass MS processing of deglycosylated nonreduced monoclonal antibodies. Peptide map module 253 is configured to automatically determine theoretical monoisotopic masses for peptide fragments.

In this example of a resource management interface 234, LC-MS 239, other equipment (“Equipment”) 240, or reagents 241 may be selected to respectively obtain information regarding each according to such category. For this example of LC-MS 239, there may be an LC-MS and preventative maintenance schedule information, as well as surrounding documentation. For this example of Equipment 240, there may be a list of available equipment. For this example of reagents 241, there may be a list of available reagents.

In this example of a client management interface 235, clients 242, contacts 243, or web contacts 244 may be selected. For this example of clients 242, client pages with project overviews may be obtained. For this example of contacts 243, company internal contacts may be obtained. For this example of web contacts 244, company external contacts may be obtained, where such external contacts may be curated through an intake web form.

FIG. 3-1 is a flow diagram depicting an example of peak flow 300. Peak flow 300 is further described with simultaneous reference to FIGS. 1-1 through 3-1. Peak flow 300 may be an implementation for a peak tool of a set of intelligent tools of platform 210.

Peak flow 300 may be initiated at operation 301 (“301”), such as by selection of an intelligent tool, such as for example intelligent tool 217. At 302, details for a project and sample information may be entered, such as via client portal 204 or directly into LIMS 205, or via ELD 207.

At 303, theoretical masses for constituent elements of a chemical composition may be determined. Such constituent elements may be obtained from or based off of input at 302.

At 304, one or more peak areas may be determined. Along those lines, experimental data 305 may be uploaded at 310 for such determination. Such experimental data may be obtained from data lake 213, such as for data results 25 stored therein. This experimental data may be obtained from MS, LC-MS, LC-MS/MS for example. Peak areas may be determined from experimental data 305.

Experimental data may be of a form of a subject dataset associated with a sample. Such a subject dataset includes mass spectrometry-based data for such subject sample. A sample may be of a drug substance or a drug product. For a sample, may be a biologic substance produced by or for a biopharma entity.

At 306, such peak areas determined at 304 may be compared with theoretical masses corresponding thereto from such theoretical masses determined at 303. At 306, percentages of one or more peak areas in comparison to related spectra, such as for example corresponding theoretical masses and experimental peaks, may be determined.

At 307, a report may be generated for this comparison. Such a report 307 generated and output may include results from such comparing of corresponding theoretical masses and experimental peaks. Such report may include such theoretical masses and such experimental peak data.

For example, a non-transitory computer-readable storage medium may have a set of analytical workflows where two thereof are configured for tandem operation. Furthermore, for example, such two of such set of analytical workflows may have one or more data dependent exchanges, which may go from either workflow to such other workflow. This may be used to accelerate operation, so as not to have to wait for data to cure an intermediate data dependency in a workflow. Such data exchanges may be in real time to enhance continuity of operation of tandem workflows. By tandem workflows, it is generally meant having two or more workflows working side-by-side at the same time.

At 308, such a report may be output. At 309, peak flow 300 may return.

FIG. 3-2 is a flow diagram depicting an example of peak flow 320. Peak flow 320 is further described with simultaneous reference to FIGS. 1-1 through 3-2. Peak flow 320 may be for another implementation for a peak tool of a set of intelligent tools of platform 210. As much of the description for peak flows 300 and 320 is the same, some description is not repeated for purposes of clarity and not limitation.

Peak flow 300 may be initiated at 301. At 302, details for a project and sample information may be entered. At 303, theoretical masses for constituent elements of a chemical composition may be determined.

At 304, one or more peak areas may be determined. Experimental data 305 may be uploaded at 310 for such determination.

At 321, a reference dataset for a subject sample may be generated or otherwise obtained. Experimental data 305 may include a subject dataset for a sample as well as a reference dataset therefor. Again, such experimental data may be obtained from data lake 213, such as for data results 25 stored therein. This experimental data may be obtained from MS, LC-MS, LC-MS/MS for example.

Experimental data 305 may be generated, currently or previously, for a standard or reference material. For example, a reference material may be obtained from National Institute of Standards and Technology (“NIST”) or elsewhere, and MS data, namely molecular-level data, may be generated from such reference material to provide a reference dataset at 321. A reference dataset may be selected at 321 for a subject sample or subject dataset in response to input obtained at 302.

Experimental data 305 may include a subject dataset associated with a sample. Such a subject dataset may include mass spectrometry-based data for such subject sample. A sample may be of a drug substance or a drug product. For example, a subject sample may be a biologic substance produced for a biopharma drug.

At 306, such peak areas determined at 304 may be compared with theoretical masses corresponding thereto from such theoretical masses determined at 303. At 322, a subject distribution may be generated for a subject dataset. At 323, a reference distribution may be generated for a reference dataset. In another example, a reference distribution may be predetermined and included as part of experimental data 305 to avoid a repeat of operation 323.

At 324, a subject distribution for a subject sample may be compared with corresponding components in a reference distribution to determine a set of relative values 325.

At 307, a report may be generated to include such set of relative values 325, as well as results from such comparing of corresponding theoretical masses and experimental peaks.

At 326, such set of relative values 325 may be converted to corresponding vectors 327. Each of such vectors 327 may represent relative abundance or lack thereof of a drug substance in a subject sample.

At 328, vectors 327 may be input to a machine-learning (“ML”) model. Such ML model may be configured to make predictions 329 based in part on input vectors 327, as well as coefficients and other parametric input to such ML model. AutoML from Microsoft may be used for such an ML model.

Other operations of peak flow 320 have been previously described, and so such description is not repeated here for purposes of clarity and not limitation.

Because one or more of the examples described herein may be implemented using an information processing system, a detailed description of examples of each of a network (such as for a Cloud-based SaaS, IaaS, or PaaS implementation), a computing system, and a mobile device is provided. However, it should be understood that other configurations of one or more of these examples may benefit from the technology described herein.

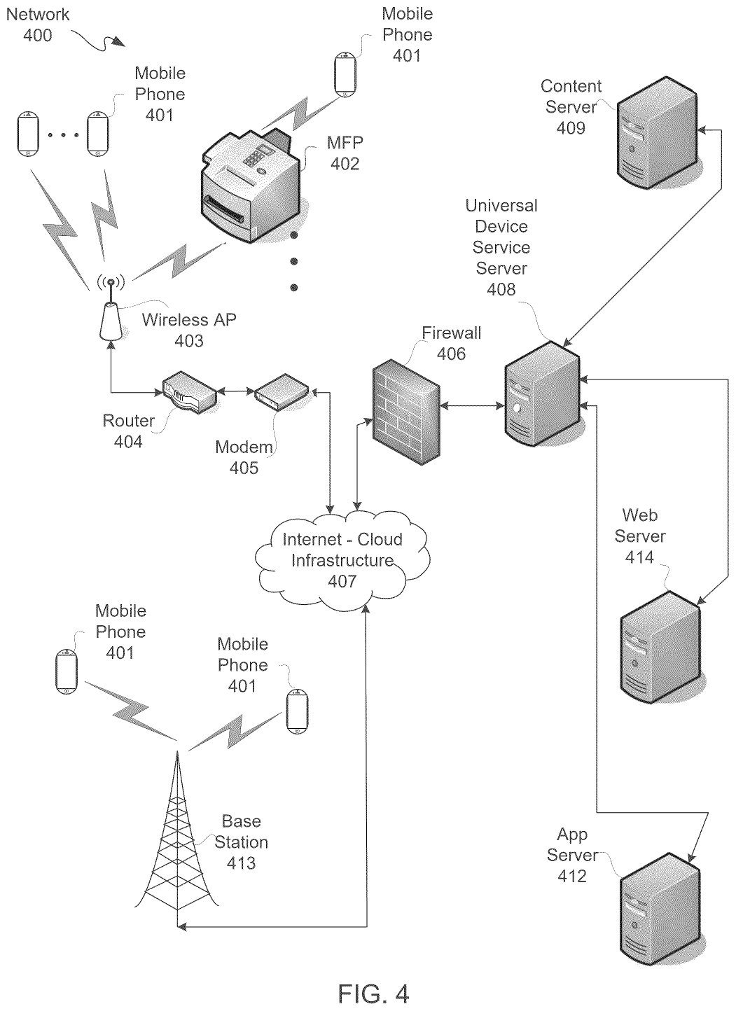

FIG. 4 is a pictorial diagram depicting an example of a network 400, which may be used to provide a SaaS, IaaS, PaaS or other platform for hosting a service or micro service for use by a user device, as described herein. Along those lines, network 400 may include one or more mobile phones, pads/tablets, notebooks, and/or other web-usable devices 401 in wired and/or wireless communication with a wired and/or wireless access point (“AP”) 403 connected to or of a wireless router. Furthermore, one or more of such web-usable wireless devices 401 may be in wireless communication with a base station 413.

Additionally, a desktop computer and/or a printing device, such as for example one or more multi-function printer (“MFPs”) 402, each of which may be web-usable devices, may be in wireless and/or wired communication to and from router 404. An MFP 402 may include at least one plasma head as previously described herein.

Wireless AP 403 may be connected for communication with a router 404, which in turn may be connected to a modem 405. Modem 405 and base station 413 may be in communication with an Internet-Cloud infrastructure 407, which may include public and/or private networks.

A firewall 406 may be in communication with such an Internet-Cloud infrastructure 407. Firewall 406 may be in communication with a universal device service server 408. Universal device service server 408 may be in communication with a content server 409, a web server 414, and/or an app server 412. App server 412, as well as a network 400, may be used for downloading an app or one or more components thereof for accessing and using a service or a micro service as described herein.

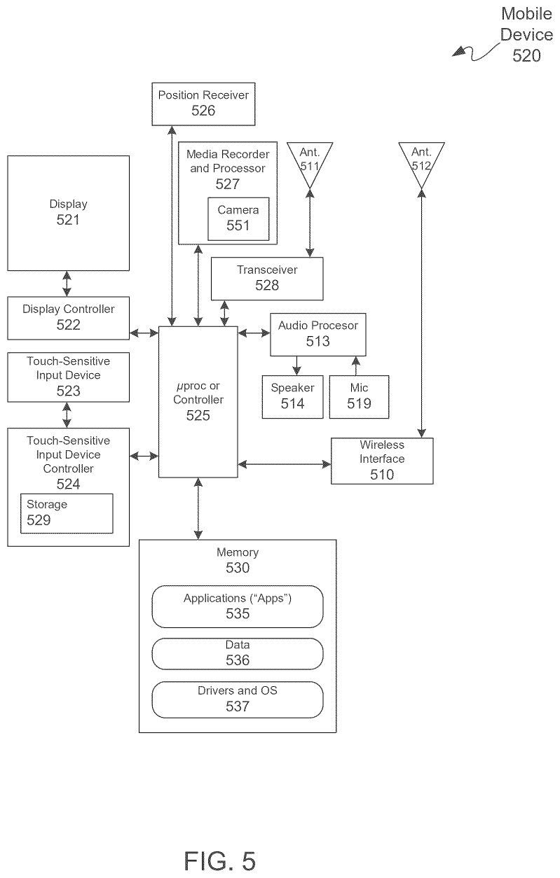

FIG. 5 is a block diagram depicting an example of a portable communication device (“mobile device”) 520. Mobile device 520 may be an example of a mobile device used to instruct a printing device.

Mobile device 520 may include a wireless interface 510, an antenna 511, an antenna 512, an audio processor 513, a speaker 514, and a microphone (“mic”) 519, a display 521, a display controller 522, a touch-sensitive input device 523, a touch-sensitive input device controller 524, a microprocessor or microcontroller 525, a position receiver 526, a media recorder 527, a cell transceiver 528, and a memory or memories (“memory”) 530.

Microprocessor or microcontroller 525 may be programmed to control overall operation of mobile device 520. Microprocessor or microcontroller 525 may include a commercially available or custom microprocessor or microcontroller.

Memory 530 may be interconnected for communication with microprocessor or microcontroller 525 for storing programs and data used by mobile device 520. Memory 530 generally represents an overall hierarchy of memory devices containing software and data used to implement functions of mobile device 520. Data and programs or apps, such as a mobile client application, may be stored in memory 530.

Memory 530 may include, for example, RAM or other volatile solid-state memory, flash or other non-volatile solid-state memory, a magnetic storage medium such as a hard disk drive, a removable storage media, or other suitable storage means. In addition to handling voice communications, mobile device 520 may be configured to transmit, receive and process data, such as Web data communicated to and from a Web server, text messages (also known as short message service or SMS), electronic mail messages, multimedia messages (also known as MMS), image files, video files, audio files, ring tones, streaming audio, streaming video, data feeds (e.g., podcasts), and so forth.

In this example, memory 530 stores drivers, such as I/O device drivers, and operating system programs (“OS”) 537. Memory 530 stores application programs (“apps”) 535 and data 536. Data may include application program data.

I/O device drivers may include software routines accessed through microprocessor or microcontroller 525 or by an OS stored in memory 530. Apps, to communicate with devices such as the touch-sensitive input device 523 and keys and other user interface objects adaptively displayed on a display 521, may use one or more of such drivers.

Mobile device 520, such as a mobile or cell phone, includes a display 521. Display 521 may be operatively coupled to and controlled by a display controller 522, which may be a suitable microcontroller or microprocessor programmed with a driver for operating display 521.

Touch-sensitive input device 523 may be operatively coupled to and controlled by a touch-sensitive input device controller 524, which may be a suitable microcontroller or microprocessor. Along those lines, touching activity input via touch-sensitive input device 523 may be communicated to touch-sensitive input device controller 524. Touch-sensitive input device controller 524 may optionally include local storage 529.

Touch-sensitive input device controller 524 may be programmed with a driver or application program interface (“API”) for apps 535. An app may be associated with a service, as previously described herein, for use of a SaaS, IaaS, or PaaS. One or more aspects of above-described apps may operate in a foreground or background mode.

Microprocessor or microcontroller 525 may be programmed to interface directly touch-sensitive input device 523 or through touch-sensitive input device controller 524. Microprocessor or microcontroller 525 may be programmed or otherwise configured to interface with one or more other interface device(s) of mobile device 520. Microprocessor or microcontroller 525 may be interconnected for interfacing with a transmitter/receiver (“transceiver”) 528, audio processing circuitry, such as an audio processor 513, and a position receiver 526, such as a global positioning system (“GPS”) receiver. An antenna 511 may be coupled to transceiver 528 for bi-directional communication, such as cellular and/or satellite communication.

Mobile device 520 may include a media recorder and processor 527, such as a still camera 551, a video camera, an audio recorder, or the like, to capture digital pictures, audio and/or video. Microprocessor or microcontroller 525 may be interconnected for interfacing with media recorder and processor 527. Image, audio and/or video files corresponding to the pictures, songs and/or video may be stored in memory 530 as data 536.

Mobile device 520 may include an audio processor 513 for processing audio signals, such as for example audio information transmitted by and received from transceiver 528. Microprocessor or microcontroller 525 may be interconnected for interfacing with audio processor 513. Coupled to audio processor 513 may be one or more speakers 514 and one or more microphones 519, for projecting and receiving sound, including without limitation recording sound, via mobile device 520. Audio data may be passed to audio processor 513 for playback. Audio data may include, for example, audio data from an audio file stored in memory 530 as data 536 and retrieved by microprocessor or microcontroller 525. Audio processor 513 may include buffers, decoders, amplifiers and the like.

Mobile device 520 may include one or more local wireless interfaces 510, such as a WIFI interface, an infrared transceiver, and/or an RF adapter. Wireless interface 510 may provide a Bluetooth adapter, a WLAN adapter, an Ultra-Wideband (“UWB”) adapter, and/or the like. Wireless interface 510 may be interconnected to an antenna 512 for communication. As is known, a wireless interface 510 may be used with an accessory, such as for example a hands-free adapter and/or a headset. For example, audible output sound corresponding to audio data may be transferred from mobile device 520 to an adapter, another mobile radio terminal, a computer, or another electronic device. In another example, wireless interface 510 may be for communication within a cellular network or another Wireless Wide-Area Network (WWAN).

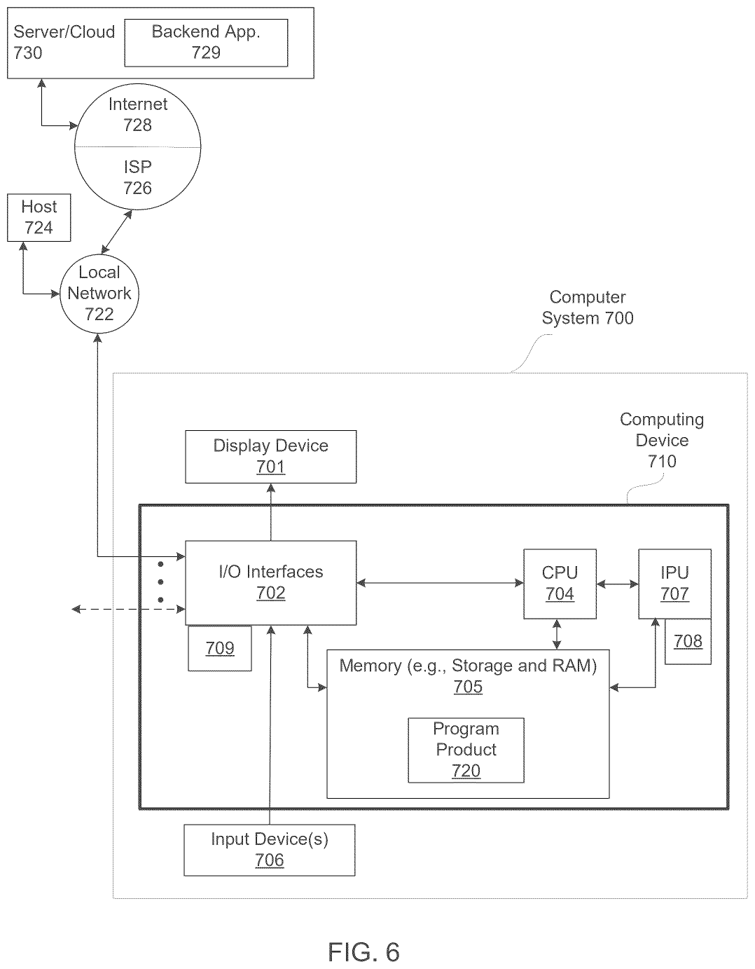

FIG. 6 is a block diagram depicting an example of a computer system 700 upon which one or more aspects described herein may be implemented. Computer system 700 may include a programmed computing device 710 coupled to one or more display devices 701, such as Cathode Ray Tube (“CRT”) displays, plasma displays, Liquid Crystal Displays (“LCDs”), Light Emitting Diode (“LED”) displays, light emitting polymer displays (“LPDs”) projectors and to one or more input devices 706, such as a keyboard and a cursor pointing device. Other known configurations of a computer system may be used. Computer system 700 by itself or networked with one or more other computer systems 700 may provide an information handling/processing system.

Programmed computing device 710 may be programmed with a suitable operating system, which may include Mac OS, Java Virtual Machine, Real-Time OS Linux, Solaris, iOS, Darwin, Android Linux-based OS, Linux, OS-X, UNIX, or a Windows operating system, among other platforms, including without limitation an embedded operating system, such as VxWorks. Programmed computing device 710 includes a central processing unit (“CPU”) 704, one or more memories and/or storage devices (“memory”) 705, and one or more input/output (“I/O”) interfaces (“I/O interface”) 702. Programmed computing device 710 may optionally include an image processing unit (“IPU”) 707 coupled to CPU 704 and one or more peripheral cards 709 coupled to I/O interface 702. Along those lines, programmed computing device 710 may include graphics memory 708 coupled to optional IPU 707.

CPU 704 may be a type of microprocessor known in the art, such as available from IBM, Intel, ARM, and Advanced Micro Devices for example. CPU 704 may include one or more processing cores. Support circuits (not shown) may include busses, cache, power supplies, clock circuits, data registers, and the like.

Memory 705 may be directly coupled to CPU 704 or coupled through I/O interface 702. At least a portion of an operating system may be disposed in memory 705. Memory 705 may include one or more of the following: flash memory, random access memory, read only memory, magneto-resistive read/write memory, optical read/write memory, cache memory, magnetic read/write memory, and the like, as well as non-transitory signal-bearing media as described below. For example, memory 705 may include an SSD, which is coupled to I/O interface 702, such as through an NVMe-PCIe bus, SATA bus or other bus. Moreover, one or more SSDs may be used, such as for NVMe, RAID or other multiple drive storage for example.

I/O interface 702 may include chip set chips, graphics processors, and/or daughter cards, among other known circuits. In this example, I/O interface 702 may be a Platform Controller Hub (“PCH”). I/O interface 702 may be coupled to a conventional keyboard, network, mouse, camera, microphone, display printer, and interface circuitry adapted to receive and transmit data, such as data files and the like.

Programmed computing device 710 may optionally include one or more peripheral cards 709. An example of a daughter or peripheral card may include a network interface card (“NIC”), a display interface card, a modem card, and a Universal Serial Bus (“USB”) interface card, among other known circuits. Optionally, one or more of these peripherals may be incorporated into a motherboard hosting CPU 704 and I/O interface 702. Along those lines, IPU 707 may be incorporated into CPU 704 and/or may be of a separate peripheral card.

Programmed computing device 710 may be coupled to a number of client computers, server computers, or any combination thereof via a conventional network infrastructure, such as a company's Intranet and/or the Internet, for example, allowing distributed use. Moreover, a storage device, such as an SSD for example, may be directly coupled to such a network as a network drive, without having to be directly internally or externally coupled to programmed computing device 710. However, for purposes of clarity and not limitation, it shall be assumed that an SSD is housed in programmed computing device 710.

Memory 705 may store all or portions of one or more programs or data, including variables or intermediate information during execution of instructions by CPU 704, to implement processes in accordance with one or more examples hereof to provide a program product 720. Program product 720 may be for implementing portions of process flows, as described herein. Additionally, those skilled in the art will appreciate that one or more examples hereof may be implemented in hardware, software, or a combination of hardware and software. Such implementations may include a number of processors or processor cores independently executing various programs, dedicated hardware and/or programmable hardware.

Along those lines, implementations related to use of computing device 710 for implementing techniques described herein may be performed by computing device 710 in response to CPU 704 executing one or more sequences of one or more instructions contained in main memory of memory 705. Such instructions may be read into such main memory from another machine-readable medium, such as a storage device of memory 705. Execution of the sequences of instructions contained in main memory may cause CPU 704 to perform one or more process steps described herein. In alternative implementations, hardwired circuitry may be used in place of or in combination with software instructions for such implementations. Thus, the example implementations described herein should not be considered limited to any specific combination of hardware circuitry and software, unless expressly stated herein otherwise.

One or more program(s) of program product 720, as well as documents thereof, may define functions of examples hereof and can be contained on a variety of non-transitory tangible signal-bearing media, such as computer- or machine-readable media having code, which include, but are not limited to: (i) information permanently stored on non-writable storage media (e.g., read-only memory devices within a computer such as CD-ROM or DVD-ROM disks readable by a CD-ROM drive or a DVD drive); or (ii) alterable information stored on writable storage media (e.g., floppy disks within a diskette drive or flash drive or hard-disk drive or read/writable CD or read/writable DVD).

Computer readable storage media encoded with program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. In implementations, information downloaded from the Internet and other networks may be used to provide program product 720. Such transitory tangible signal-bearing media, when carrying computer-readable instructions that direct functions hereof, represent implementations hereof.

Along those lines the term “tangible machine-readable medium” or “tangible computer-readable storage” or the like refers to any tangible medium that participates in providing data that causes a machine to operate in a specific manner. In an example implemented using computer system 700, tangible machine-readable media are involved, for example, in providing instructions to CPU 704 for execution as part of programmed product 720. Thus, a programmed computing device 710 may include programmed product 720 embodied in a tangible machine-readable medium. Such a medium may take many forms, including those describe above.

The term “transmission media”, which includes coaxial cables, conductive wire and fiber optics, including traces or wires of a bus, may be used in communication of signals, including a carrier wave or any other transmission medium from which a computer can read. Transmission media can also take the form of acoustic or light waves, such as those generated during radio-wave and infra-red data communications.

Various forms of tangible signal-bearing machine-readable media may be involved in carrying one or more sequences of one or more instructions to CPU 704 for execution. For example, instructions may initially be carried on a magnetic disk or other storage media of a remote computer. The remote computer can load the instructions into its dynamic memory and send such instructions over a transmission media using a modem. A modem local to computer system 700 can receive such instructions on such transmission media and use an infra-red transmitter to convert such instructions to an infra-red signal. An infra-red detector can receive such instructions carried in such infra-red signal and appropriate circuitry can place such instructions on a bus of computing device 710 for writing into main memory, from which CPU 704 can retrieve and execute such instructions. Instructions received by main memory may optionally be stored on a storage device either before or after execution by CPU 704.

Computer system 700 may include a communication interface as part of I/O interface 702 coupled to a bus of computing device 710. Such a communication interface may provide a two-way data communication coupling to a network link connected to a local network 722. For example, such a communication interface may be a local area network (“LAN”) card to provide a data communication connection to a compatible LAN. Wireless links may also be implemented. In any such implementation, a communication interface sends and receives electrical, electromagnetic or optical signals that carry digital and/or analog data and instructions in streams representing various types of information.

A network link to local network 722 may provide data communication through one or more networks to other data devices. For example, a network link may provide a connection through local network 722 to a host computer 724 or to data equipment operated by an Internet Service Provider (“ISP”) 726 or another Internet service provider. ISP 726 may in turn provide data communication services through a world-wide packet data communication network, the “Internet” 728. Local network 722 and the Internet 728 may both use electrical, electromagnetic or optical signals that carry analog and/or digital data streams. Data carrying signals through various networks, which carry data to and from computer system 700, are exemplary forms of carrier waves for transporting information.

Wireless circuitry of I/O interface 702 may be used to send and receive information over a wireless link or network to one or more other devices' conventional circuitry such as an antenna system, an RF transceiver, one or more amplifiers, a tuner, one or more oscillators, a digital signal processor, a CODEC chipset, memory, and the like. In some implementations, wireless circuitry may be capable of establishing and maintaining communications with other devices using one or more communication protocols, including time division multiple access (TDMA), code division multiple access (CDMA), global system for mobile communications (GSM), Enhanced Data GSM Environment (EDGE), wideband code division multiple access (W-CDMA), Long Term Evolution (LTE), LTE-Advanced, WIFI (such as IEEE 802.11a, IEEE 802.11b, IEEE 802.11g and/or IEEE 802.11n), Bluetooth, Wi-MAX, voice over Internet Protocol (VoIP), near field communication protocol (NFC), a protocol for email, instant messaging, and/or a short message service (SMS), or any other suitable communication protocol. A computing device can include wireless circuitry that can communicate over several different types of wireless networks depending on the range required for the communication. For example, a short-range wireless transceiver (e.g., Bluetooth), a medium-range wireless transceiver (e.g., WIFI), and/or a long range wireless transceiver (e.g., GSM/GPRS, UMTS, CDMA2000, EV-DO, and LTE/LTE-Advanced) can be used depending on the type of communication or the range of the communication.

Computer system 700 can send messages and receive data, including program code, through network(s) via a network link and communication interface of I/O interface 702. In the Internet example, a server 730 might transmit a requested code for an application program through Internet 728, ISP 726, local network 722 and I/O interface 702. A server/Cloud-based system 730 may include a backend application for providing one or more applications or services as described herein. Received code may be executed by processor 704 as it is received, and/or stored in a storage device, or other non-volatile storage, of memory 705 for later execution. In this manner, computer system 700 may obtain application code in the form of a carrier wave.

While the foregoing describes exemplary embodiment(s) in accordance with one or more aspects of the disclosure, other and further embodiment(s) in accordance with the one or more aspects of the disclosure may be devised without departing from the scope thereof, which is determined by the claim(s) that follow and equivalents thereof. Each claim of this document constitutes a separate embodiment, and embodiments that combine different claims and/or different embodiments are within the scope of the disclosure and will be apparent to those of ordinary skill in the art after reviewing this disclosure. Claim(s) listing steps do not imply any order of the steps. Trademarks are the property of their respective owners.

What is claimed is:

1. A method, comprising:
obtaining information regarding a sample;
determining theoretical masses of constituent elements of the sample;
obtaining experimental data for the sample using mass spectrometry;
determining peak areas for the experimental data; and
comparing the peak areas and the theoretical masses to determine percentages of peak areas in comparison to the theoretical masses associated therewith.

2. The method according to claim 1, further comprising generating a report including results from the comparing.

3. The method according to claim 2, wherein the report further includes the theoretical masses and the experimental data.

4. The method according to claim 1, wherein:
the experimental data is of a form of a subject dataset associated with the sample;
the subject dataset includes mass spectrometry-based data; and
the peak areas correspond to concentrations of the constituent elements from the subject dataset.

5. The method according to claim 4, wherein the sample is of a drug substance.

6. The method according to claim 5, wherein the drug substance is a biologic substance.

7. The method according to claim 5, further comprising generating a reference dataset for the subject dataset.

8. The method according to claim 7, further comprising:
generating a subject distribution for the subject dataset;
generating a reference distribution for the reference dataset; and
comparing the subject distribution with corresponding components in the reference distribution to determine a set of relative values.

9. The method according to claim 8, further comprising converting the set of relative values to vectors representing relative abundance or lack thereof of the drug substance in the sample.

10. An apparatus, comprising:
a processor;
a storage device storing instructions that when executed by the processor causes the processor to provide for display of an interactive graphical user interface; and
the interactive graphical user interface including:
a laboratory inventory management system module configured for managing projects, samples and inventories;
an electronic lab notebook module in communication laboratory inventory management system module;
a platform module in communication with the electronic lab notebook module; and
the platform module providing access to a set of analytical workflows and a set of intelligent tools.

11. The apparatus according to claim 10, wherein:
the set of analytical workflows are configured for tandem operation of two of the set of analytical workflows; and
the two of the set of analytical workflows have data dependent exchanges.

12. The apparatus according to claim 10, wherein the set of intelligent tools comprises a peak tool that when executed by the processor causes the processor to perform steps comprising:
obtaining information regarding the sample;
determining theoretical masses of constituent elements of the sample;
obtaining experimental data for the sample from mass spectrometry;
determining peak areas for the experimental data; and
comparing the peak areas and the theoretical masses to determine percentages of peak areas in comparison to the theoretical masses associated therewith.

13. The apparatus according to claim 12, wherein the steps further comprise generating a report including results from the comparing.

14. The apparatus according to claim 13, wherein the report further includes the theoretical masses and the experimental data.

15. The apparatus according to claim 12, wherein:
the experimental data is of a form of a subject dataset associated with the sample;
the subject dataset includes mass spectrometry-based data; and
the peak areas correspond to concentrations of the constituent elements from the subject dataset.

16. The apparatus according to claim 15, wherein the sample is of a drug substance.

17. The apparatus according to claim 16, wherein the drug substance is a biologic substance.

18. The apparatus according to claim 15, wherein the steps further comprise generating a reference dataset for the subject dataset.

19. The apparatus according to claim 18, wherein the steps further comprise:
generating a subject distribution for the subject dataset;
generating a reference distribution for the reference dataset; and
comparing the subject distribution with corresponding components in the reference distribution to determine a set of relative values.

20. The apparatus according to claim 19, wherein the steps further comprise converting the set of relative values to vectors representing relative abundance or lack thereof of the drug substance in the sample.
